(19) United States
(12) Patent Application Publication
(10) Pub. No.: US 2006/0214422 A1
(43) Pub. Date: Sep. 28, 2006

(54) Pipe coupling retainer with axial support members

(75) Inventors: Anthony J. Cuvo, Coopersburg, PA (US); Thomas A. Guiditta, Watertown, CT (US)

Correspondence Address: SYNNESTVEDT & LECHNER, LLP, 2600 ARAMARK TOWER, 1101 MARKET STREET, PHILADELPHIA, PA, 191072950, US

(73) Assignee: Victaulic Company fo America, Easton, PA (US)

(21) Appl. No.: 11/091,257

(22) Filed: Mar. 28, 2005

(51) Int. Cl. F16L 19/08

(52) U.S. Cl. 285/340

(57) ABSTRACT

A retainer for use in a mechanical pipe coupling is disclosed. The retainer fits within an expanded region of the coupling adjacent to a washer which is adjacent to an incompressible seal. The retainer has a band with opposite edges. Angularly oriented retaining teeth extend inwardly from one edge and engage a pipe inserted into the coupling. Axial support members, arranged in spaced angular intervals circumferentially around the band, extend from the same edge and project toward the opposite edge. The support members are substantially parallel to the band and have ends that engage the washer and exert an axial force to prevent it from telescoping into the band when the seal is under pressure and tries to expand and displace the washer.

### FIELD OF THE INVENTION

This invention relates to retainers used with mechanical pipe couplings which effect a strong, reliable joint with a fluid-tight seal without the need for brazing or soldering.

### BACKGROUND OF THE INVENTION

The construction of piping networks requires couplings that can form fluid-tight joints between pipe ends which can withstand external mechanical forces, as well as internal fluid pressure and reliably maintain the integrity of the joint. Many forms of joints are known, such as brazed or soldered joints, threaded joints, welded joints and joints effected by mechanical means.

There are standard pipe fittings such as elbows (45° and 90°), tees and straight segments matched for use with standard tube diameters. The standard fittings have open ends with inner diameters sized to accept the outer diameter of a particular standard tube in mating contact for effecting a joint.

In addition to the standard fittings described above, other components, such as valves, strainers, adapters, flow measurement devices and other components which may be found in a pipe network, will have a coupling which is compatible with the standard pipe, and it is understood that the term “coupling”, when used herein, is not limited to a standard elbow, tee or other fitting but includes the open end of any component useable in a piping network which serves to couple the component to the pipe end.

The soldered joint is used to a great extent for pipe couplings. This joint is effected between a standard diameter tube end and its associated standard fitting by first cleaning the surfaces to be joined, typically with an abrasive such as a wire brush or steel wool, to remove any contaminants and the oxide layer which forms on the surfaces. Next, the cleaned surfaces are coated with a flux material, usually an acid flux, which further disrupts the oxide layer (especially when heated) and permits metal to metal contact between the fitting, the pipe end and the solder. The pipe end is next mated with the fitting thereby bringing the cleaned, flux coated surfaces into contact. The fitting and pipe end are then heated to the melting temperature of the solder, and the solder is applied to the interface between the tube and the fitting. The solder melts, flows between the surfaces of the pipe end and the fitting via capillary action and upon cooling and solidifying forms the solder joint. Excess flux is removed from the outer surfaces to prevent further acid etching of the pipe near the joint.

While the soldered joint provides a strong, fluid-tight connection between pipe end and fitting, it has several disadvantages. Many steps are required to make the soldered joint, thus, it is a time consuming and labor intensive operation. Some skill is required to obtain a quality, fluid-tight joint. Furthermore, the solder often contains lead, and the flux, when heated, can give off noxious fumes, thus, exposing the worker to hazardous substances which can adversely affect health over time. The joint is typically heated with an open gas flame which can pose a fire hazard, as well as a personal burn hazard.

To overcome these disadvantages, many attempts have been made to create mechanical couplings which do not require solder or flame to effect a strong, fluid-tight joint. Such mechanical couplings may comprise a housing having a socket for receiving the pipe end. Adjacent to the socket is an expanded region which accommodates components such as an elastomeric seal for sealing purposes, an annular retainer interposed between the outer diameter of the pipe end and the inner diameter of the coupling to mechanically hold the parts together, a washer positioned between the seal and the retainer and a support collar positioned between the retainer and the opening of the housing. The support collar, in conjunction with the socket, provides a two point support for the pipe end and augments the bending stiffness of the coupling. The washer prevents the seal from being displaced into the retainer under hydraulic pressure. Without the washer, the seal may ride up on the retainer teeth, unseat itself from the pipe end, and form a leak path within the coupling.

The retainer may have a band from which teeth extend radially inwardly to dig into the surface of the pipe end to resist extraction of the pipe end from the coupling after engagement. In such a coupling, the washer and the band have diameters that are close in size, and it is found that the washer may be forced within the band by pressure placed upon the washer by the seal as it deforms when a pipe end is engaged within the coupling or by the hydraulic pressure of the fluid within the pipe. If the washer “telescopes” into the retainer band then the seal is not properly confined within the housing and may lose its preload against the pipe and the housing, resulting in a leaky joint.

It is clearly advantageous to develop a retainer for a coupling wherein the telescoping of the washer into the retainer is prevented so as to maintain the fluid tight integrity of the joint.

### SUMMARY OF THE INVENTION

The invention concerns a retainer positionable within a pipe coupling for retaining a pipe end within the coupling. The retainer comprises a circumferential band surrounding a central axis. The band has an outwardly facing surface engageable with an inwardly facing surface of the pipe coupling. The band also has first and second edges oppositely disposed. A plurality of teeth are attached to the first edge of the band. The teeth project inwardly and are angularly oriented toward the second edge of the band. The ends of the teeth are engageable with the pipe when it is positioned within the band. A plurality of axial support members are also attached to the first edge of the band. The support members project axially toward the second edge of the band and have a predetermined length at least as long as the width of the band enabling them to exert an axial force when they engage an adjacent component.

Preferably, the retainer has at least three of the axial support members. The support members are preferably spaced around the band at equal angular intervals. Each of the support members preferably has a flat engagement surface positioned at its end. The support members are also preferably oriented substantially parallel to the band and are in spaced apart relation with respect to the band.

The invention also includes a coupling assembly for receiving an end of a pipe. The coupling assembly comprises a housing having a socket for receiving the pipe end and an expanded region positioned adjacent to the socket. A seal is positioned within the expanded region adjacent to the socket, the seal being sealingly engageable with the housing and the pipe. A washer is positioned within the expanded region adjacent to the seal. An annular retainer, as described above, is positioned within the expanded region adjacent to the washer. Within the expanded region the washer engages the seal, the support members engage the washer and exert an axial force that prevents any portion of the washer from moving within the band when the seal is subject to pressure within the housing.

### BRIEF DESCRIPTION OF THE DRAWINGS

FIG. 1 is a perspective view of a retainer according to the invention;

FIG. 1A is a perspective view of a portion of the retainer shown in FIG. 1;

FIG. 2 is a longitudinal sectional view of a coupling assembly using a retainer according to the invention;

FIG. 3 is an exploded perspective view of a coupling assembly in the form of an elbow fitting using a retainer according to the invention; and

FIG. 4 is a partial plan view taken along lines 4-4 of FIG. 1.

### DETAILED DESCRIPTION OF THE PREFERRED EMBODIMENT

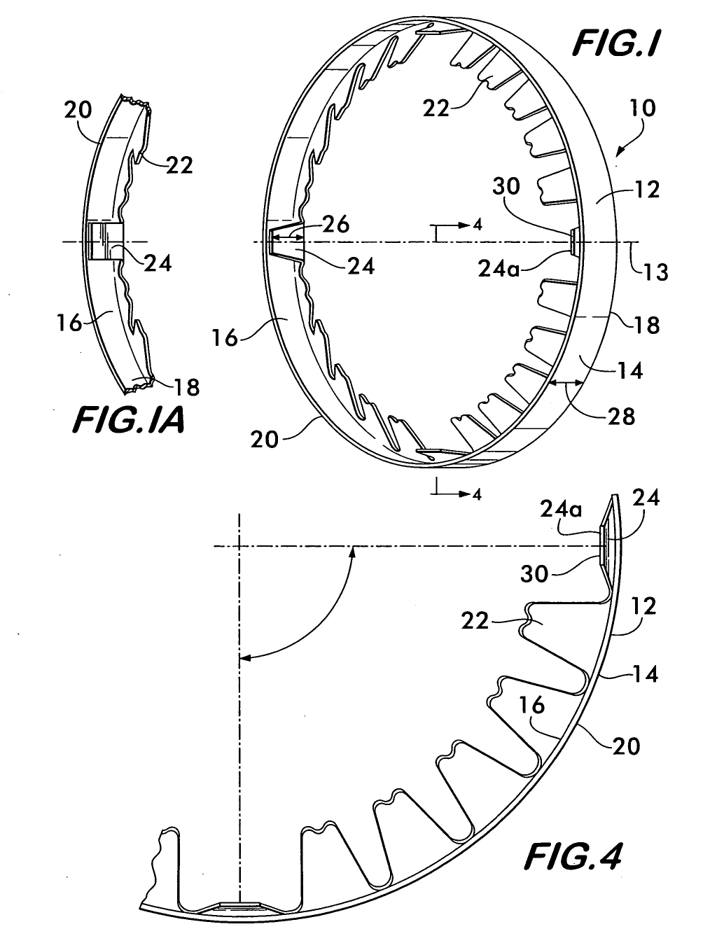

FIG. 1 shows a retainer 10 according to the invention. Retainer 10 comprises a band 12 that extends circumferentially and surrounds a central axis 13. Band 12 is preferably thin walled and has an outwardly facing surface 14 and an inwardly facing surface 16. Band 12 has a leading edge 18 and a free edge 20 oppositely disposed from the leading edge. A plurality of retaining teeth 22 are attached to the leading edge 18 and project inwardly toward the central axis 13. The retaining teeth 22 are angularly oriented and slope toward the free edge 20 for reasons explained below.

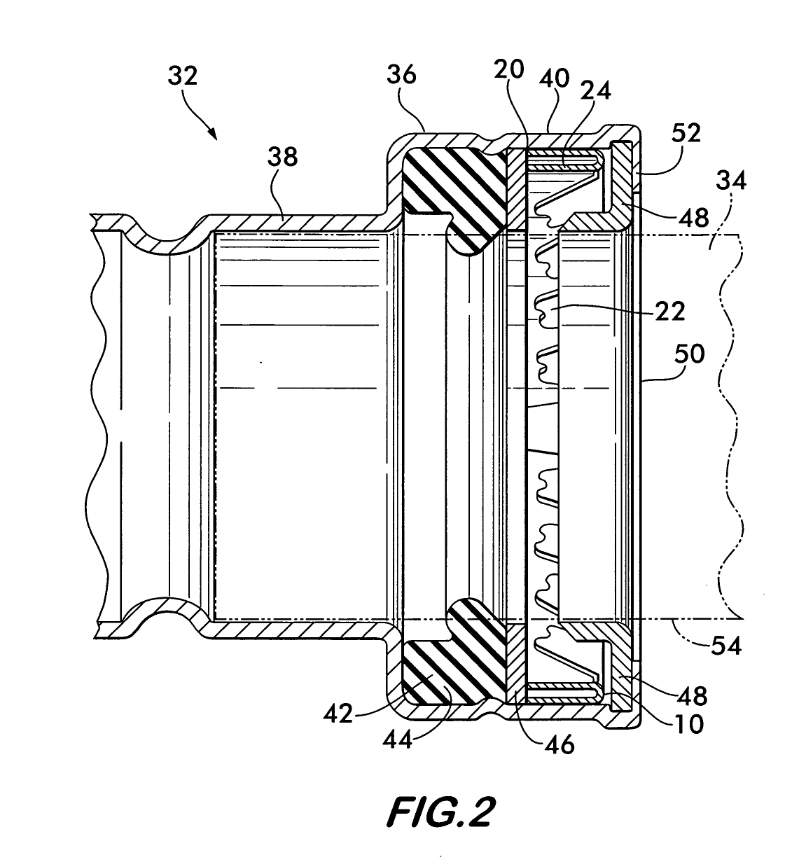

As best shown in FIGS. 1 and 4, a plurality of axial support members 24 are also attached to the leading edge 18 of band 12. Support members 24 may be tapered or straight sided (as shown in FIG. 1A) and project axially toward the free edge 20, allowing them to exert a force substantially parallel to the central axis 13. Support members 24 have a predetermined length 26 that is at least as long as the width 28 of band 12 so that the ends 24a of support members 24 extend to a position at least adjacent to free edge 20. Retainer 10 has at least three support members 24, with four being preferred as shown. The support members are preferably spaced circumferentially around the band at substantially equal angular intervals as indicated in FIGS. 1 and 4. Preferably, support members 24 are in substantially parallel, spaced apart relation relatively to the inwardly facing surface 16 of band 12 (see also FIG. 2). Ends 24a of each support member 24 preferably have a flat engagement surface 30 for engaging components in a coupling assembly as described below.

The retainer is preferably made from durable, corrosion-resistant metals such as stainless steel, and thus, it may be readily formed by punching operations. The band thickness will vary according to the size of the retainer with large diameter bands having greater thickness than smaller diameter bands. Preferred band thicknesses range between about 0.010 and about 0.020 inches, and band widths 28 range between about 0.10 and about 0.30 inches.

As shown in FIG. 2, retainer 10 is one of several internal components used with a coupling assembly 32 for receiving a pipe end 34, shown in phantom line. Coupling assembly 32 provides a fluid tight joint with the pipe end 34 and includes a housing 36 with a socket 38 adapted to receive and support the pipe end 34. Housing 36 has an expanded region 40 adjacent to the socket where the internal components reside. Positioned within the expanded region 40 adjacent to the socket 38 is a seal 42. Preferably, seal 42 is an elastomeric loop 44 that is compressed between the pipe end 34 and the housing 36 to effect a fluid-tight seal. A washer 46 is positioned within the expanded region 40 adjacent to the seal, and the retainer 10 is positioned adjacent to the washer 46 with its free edge 20 facing the washer. A support collar 48 may be positioned adjacent to the retainer 10 at the opening 50 of the housing 36 which receives the pipe end 34. The various components are held within the expanded region, for example, by a retaining lip 52 extending circumferentially around the housing and projecting radially inwardly.

When seal 42, which is substantially incompressible, is subjected to pressure, for example, outward radial pressure from contact with pipe end 34 and hydraulic pressure from fluid within the pipe and coupling, it will tend to expand longitudinally and force the washer 46 into contact with the free edge 20 of retainer 10. The pressure exerted on the washer 46 by the seal 42 may be great enough to force the washer coaxially into the band 12. This condition is undesirable as it will tend to relieve the pressure between the pipe end 34 and the seal 42, as well as between the housing 36 and the seal. If the pressure on seal 42 is relaxed, then it will tend to leak at a lower pressure. The ends 24a of support members 24, positioned at spaced angular intervals around band 12, engage the washer 46 and exert an axial force preventing it from “telescoping” coaxially into the band 12 and thereby maintain the pressure on the seal to ensure a fluid tight joint between the coupling housing 36 and the pipe 34. The support members 24 also prevent a portion of the washer 46 from being forced into the retainer. In the absence of the support members, this may happen when the washer 46 and the retainer 10 are positioned eccentrically to one another within the coupling housing 36, as can occur due to varying manufacturing tolerances between the parts. With the eccentric positioning, a portion of the washer perimeter will not be supported by the free edge 20 of band 12, and thus, when the washer 46 is subjected to pressure from the seal 42, the washer may tend to rotate or bend and its unsupported portion may be forced into the retainer. With axially oriented support members 24, however, there is always adequate support of the washer perimeter to prevent its entry into the retainer 10 regardless of the relative eccentricity between the washer and the retainer due to manufacturing tolerances.

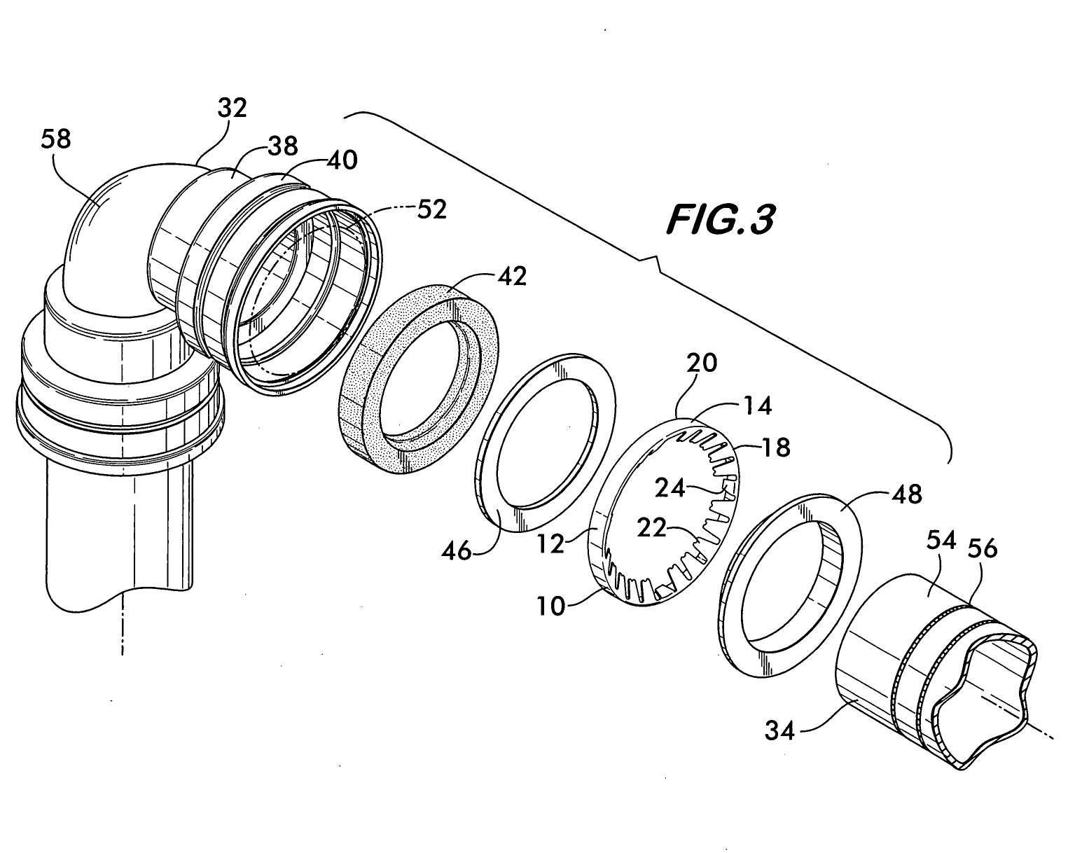

Retaining teeth 22, arranged around the leading edge 18 of band 12, project inwardly and engage the peripheral surface portion 54 of the pipe end 34. Because they are angularly oriented to slope toward the free edge 20 and are biased into engagement with pipe 34, the teeth allow the pipe to be inserted through opening 50 and into socket 38, but prevent extraction of the pipe end from the housing. The retaining action of teeth 22 may be augmented by the use of circumferential grooves 56 in the pipe end 34 as shown in FIG. 3. The retaining teeth engage the grooves 56 when present, the grooves providing additional purchase for the teeth 22 in the peripheral portion 54 of the pipe end 34.

FIG. 3 provides an exploded view of an embodiment of a coupling 32 according to the invention. In this view the coupling has an elbow shaped housing 58 which has a socket 38 and an adjacent expanded region 40. The seal 42, washer 46, retainer 10 and support collar 48 are positioned within the expanded region and held in place, for example, by the retaining lip 52, shown in phantom line. The retainer 10 may be used in any type of coupling, for example, a straight coupling, a tee, and elbow (shown) as well as couplings that incorporate fittings such as valves, strainers, reducers, expanders and orifices.

Couplings according to the invention provide a mechanical pipe coupling which can form a reliable fluid-tight joint without the hazards associated with brazing, welding or soldering. Use of the retainer ensures a reliable joint with a fluid tight seal that will not allow the seal to relax and thereby withstand relatively higher pressures.

What is claimed is:

1. A retainer positionable within a pipe coupling for retaining a pipe end within said coupling, said retainer comprising:
a circumferential band surrounding a central axis and having an outwardly facing surface engageable with an inwardly facing surface of said pipe coupling, said band having first and second edges oppositely disposed;
a plurality of teeth attached to said first edge of said band and projecting inwardly, said teeth being angularly oriented toward said second edge of said band and being engageable with said pipe when positioned within said band; and
a plurality of support members projecting axially from said first edge of said band toward said second edge, said support members adapted to apply an axial force in a direction substantially parallel to said central axis.

2. A retainer according to claim 1, wherein said support members have a predetermined length at least as long as the width of said band.

3. A retainer according to claim 1, wherein said support members all have substantially the same length.

4. A retainer according to claim 1, wherein said band has a width between about 0.10 inches and about 0.30 inches.

5. A retainer according to claim 1, comprising at least three of said support members.

6. A retainer according to claim 1, wherein said support members are spaced around said band at substantially equal angular intervals.

7. A retainer according to claim 1, wherein each of said support members has a flat engagement surface positioned at its end.

8. A retainer according to claim 1, wherein said support members are oriented substantially parallel to said band.

9. A retainer according to claim 8, wherein said support members are in spaced apart relation with respect to said band.

10. A retainer positionable within a pipe coupling for retaining a pipe end within said coupling, said retainer comprising:
a circumferential band surrounding a central axis and having an outwardly facing surface engageable with an inwardly facing surface of said pipe coupling, said band having first and second edges oppositely disposed;
a plurality of teeth attached to said first edge of said band and projecting inwardly, said teeth being angularly oriented toward said second edge of said band and being engageable with said pipe when positioned within said band; and
a plurality of support members projecting axially from said first edge of said band toward said second edge, said support members being oriented substantially parallel to said band and having a predetermined length at least as long as the width of said band, said support members adapted to apply an axial force in a direction substantially parallel to said central axis.

11. A retainer according to claim 10, comprising at least three of said support members.

12. A retainer according to claim 10, wherein said support members are spaced around said band at substantially equal angular intervals.

13. A retainer according to claim 10, wherein each of said support members has a flat engagement surface positioned at its end.

14. A retainer according to claim 10, wherein said support members are in spaced apart relation with respect to said band.

15. A coupling assembly for receiving an end of a pipe, said coupling assembly comprising:
a housing having a socket for receiving said pipe end and an expanded region positioned adjacent to said socket;
a seal positioned within said expanded region adjacent to said socket, said seal being sealingly engageable with said housing and said pipe;
a washer positioned within said expanded region adjacent to said seal;
an annular retainer positioned within said expanded region adjacent to said washer, said retainer comprising a circumferential band surrounding a central axis and having an outwardly facing surface, said band having first and second edges oppositely disposed;
a plurality of teeth projecting angularly inwardly from said first edge toward a peripheral surface portion of said pipe, said teeth being engageable with said peripheral surface portion for retaining said pipe within said housing; and
a plurality of support members projecting axially from said first edge toward said second edge of said band, said washer engaging said seal, said support members engaging said washer and exerting an axial force preventing any portion of said washer from moving within said band when said seal is subject to pressure within said housing.

16. A coupling assembly according to claim 15, wherein said support members have a predetermined length at least as long as the width of said band.

17. A coupling assembly according to claim 15, wherein said retainer has at least three of said support members.

18. A coupling assembly according to claim 15, wherein each of said support members has a flat engagement surface positioned at its end, said flat engagement surface engaging said washer.

19. A coupling assembly according to claim 15, wherein said support members are oriented substantially parallel to said band.

20. A coupling assembly according to claim 19, wherein said support members are in spaced apart relation with respect to said band.
